(19) United States
(12) Patent Application Publication
(10) Pub. No.: US 2026/0002422 A1
(43) Pub. Date: Jan. 1, 2026

(54) METHOD OF USING DEGRADABLE GLASS FIBERS FOR DOWNHOLE TOOLS

(71) Applicant: Halliburton Energy Services, Inc., Houston, TX (US)

(72) Inventors: Somen Kumar Bhudolia, Singapore (SG); Michael Linley Fripp, Singapore (SG); Sandeep Thatathil, Singapore (SG); Vishal Vilas Raut, Singapore (SG); Arpana Singh, Singapore (SG)

(73) Assignee: Halliburton Energy Services, Inc., Houston, TX (US)

(21) Appl. No.: 18/759,316

(22) Filed: Jun. 28, 2024

(51) Int. Cl. E21B 29/02; C08J 5/24

(52) U.S. Cl. CPC E21B 29/02; C08J 5/244; C08J 5/247; E21B 2200/08

(57) ABSTRACT

A method for removing a downhole tool may include: contacting a downhole tool with a fluid having a pH of greater than 7, wherein the downhole tool comprises a composite of a polymer matrix reinforced with degradable glass fibers; and degrading the degradable glass fibers using the fluid having a pH of greater than 7.

### BACKGROUND

Boreholes may be drilled into subterranean formations to recover valuable hydrocarbons, among other functions. Operations may be performed before, during, and after the borehole has been drilled to produce and continue the flow of the hydrocarbon fluids to the surface. Downhole tools in the borehole or wellbore may facilitate the production of the hydrocarbon fluids from the subterranean formation. Dissolvable downhole components such as frac plugs are utilized in various stages of constructing a wellbore and during production. Glass fibers are often incorporated in composite dissolvable frac and bridge plugs. However, once the matrix of the frac plug is dissolved the glass fibers remain as a bird's nest in the wellbore and can be difficult to remove.

### BRIEF DESCRIPTION OF THE DRAWINGS

These drawings illustrate certain aspects of some of the embodiments of the present disclosure and should not be used to limit or define the disclosure.

FIG. 1A illustrates a method to modify the surface of a glass fiber to include a layer of hydroxide releasing agent, in accordance with some embodiments.

FIG. 1B illustrates a method to modify the surface of a glass fiber to include a layer of hydroxide releasing agent, in accordance with some embodiments.

FIG. 2 illustrates a well site that includes a wellbore and a downhole tool comprising a composite of a polymer matrix reinforced with degradable glass fibers, in accordance with some embodiments.

FIG. 3 is an example of a dissolvable tool mandrel comprising a composite of a polymer matrix reinforced with degradable glass fibers, in accordance with some embodiments.

FIG. 4 is an example of a dissolvable tool mandrel comprising a composite of a polymer matrix reinforced with degradable glass fibers, in accordance with some embodiments.

FIG. 5 is a filament winding system for producing a downhole tool comprising a composite of a polymer matrix reinforced with degradable glass fibers, in accordance with some embodiments.

FIG. 6 is a bladder molding system for producing a downhole tool comprising a composite of a polymer matrix reinforced with degradable glass fibers, in accordance with some embodiments.

### DETAILED DESCRIPTION

Disclosed herein are downhole tools comprising a composite of a polymer matrix reinforced with degradable glass fibers. Further disclosed herein are methods of utilizing the downhole tool comprising degradable glass fibers whereby the downhole tool is disposed in a wellbore and thereafter contacted with an alkaline fluid to dissolve the degradable glass fibers. The downhole tool degrades in the wellbore in response to presence of an alkaline fluid such as a water-based fluid having pH of at greater than 7. This alkaline fluid can be introduced into the wellbore by pumping from the surface, and/or generated downhole in the wellbore by reacting an existing downhole fluid with a solid precursor (e.g., sodium hydroxide, potassium hydroxide, calcium hydroxide, etc.) to form the alkaline fluid.

In embodiments, downhole tools comprising the degradable glass fiber include frac plugs, frac balls, frac sleeves, ball seats, inflow control device (ICD) plugs, perforation charge carrier, perforating gun assemblies, packers, bridge plugs, and wiper plugs for example. In further embodiments, the downhole tool includes one or more components or parts which include a polymer matrix and degradable glass fibers.

The disclosed downhole tools and methods have several advantages over presently used downhole tools, only some of which may be explicitly disclosed herein. In embodiments, the downhole tools of the present disclosure allow for a more complete dissolution of the downhole tools without the need for additional well interventions to remove the downhole tool. In embodiments, a downhole tool of the present disclosure may be removed by introducing or generating an alkaline fluid into the wellbore which dissolves the glass fibers without the need for drilling the downhole tool or retrieving the downhole tool by a conveyance such as a wireline, slick line, or coiled tubing. In embodiments, the downhole tools of the present disclosure can be placed in a wellbore which comprises the alkaline fluid such that after placement, the downhole tool begins to degrade without the need for additionally introducing or generating the alkaline fluid.

In embodiments, the polymer matrix of the downhole tool is dissolvable such that the matrix additionally degrades. The polymer matrix may be dissolvable in the alkaline fluid or in an additional dissolving fluid which can be subsequently introduced into the wellbore. In embodiments, the additional dissolving fluid is present in the wellbore when the downhole tool is introduced into the wellbore such that the downhole tool begins to degrade without the need for introduction of the additional dissolving fluid. In embodiments, the polymer matrix is dissolvable in the alkaline fluid.

In utilizing degradable glass fibers a dissolvable material, downhole tools can be manufactured from degradable glass fiber and polymer matrix by injection molding, extrusion, compression molding, casting, hand layup, liquid injection techniques, tape layup, fiber placement, filament winding, pultrusion, resin transfer molding, and other allied polymer and polymer composite manufacturing techniques. For a composite of degradable glass fibers and polymer matrix, the degradable glass fibers can include short fibers, milled fibers, long fibers, continuous fibers, particles, and other fillers as reinforcement in the polymer matrix. The degradable glass fibers include any suitable glass fibers including those manufactured from C glass, D glass, E glass, E glass with boron, E glass without boron, ECR glass, R glass, S2 glass, and combinations thereof, for example.

In embodiment, the downhole tools include an additional fiber including carbon fiber, glass, aramid fiber, boron based fibers, basalt fibers, metal fibers, polyethylene fibers, aromatic polyester fibers, liquid crystal polymers, polypropylene fibers, poly(p-phenylene-2,6-benzobisoxazole) fibers, and others. In embodiments, the downhole tools include a fillers including, for instance, micro-fillers (particles or micro-tubes) and nanofillers (particles or nanotubes), such as carbon black, graphite, boron, graphene, glass, silica, pigment, or other nanotubes.

In embodiments, the polymer matrix in the downhole tools includes a thermoset polymer, a thermoplastic polymer, aromatic copolyester thermoset, and/or an aliphatic polyester. In some embodiments, the thermoset polymer matrix includes polyester resins, epoxy resins, vinylester resins, and combinations thereof. In some embodiments, the thermoplastic polymer includes acrylonitrile butadiene styrene (ABS), nylon, acrylic, polyetherimide (PEI), polyether ether ketone (PEEK), polyetherketoneketone (PEKK), and combinations thereof. In some embodiments, the aliphatic polyester includes poly(lactic acid) (PLA), poly(ε-caprolactone), poly(glycolic acid) (PGA), poly(lactic-co-glycolic acid), poly(hydroxyl ester ether), poly(hydroxybutyrate), poly(anhydride), polycarbonate, poly(amino acid), poly(ethylene oxide), poly(phosphazene), polyether ester, polyester amide, polyamides, sulfonated polyesters, poly(ethylene adipate), polyhydroxyalkanoate, poly(ethylene terephtalate), poly(butylene terephthalate), poly(trimethylene terephthalate), poly(ethylene naphthalate) and copolymers, blends, derivatives or combination of any of the aliphatic polyesters. In further embodiments, the polymer matrix includes aromatic copolyester thermoset (ACT).

The ACT is formed by crosslinking oligomers that have lower molecular weight than the ACT. Both the oligomers (before crosslinking) and the ACT (as a thermoset after crosslinking) can have the following structure in a repeat unit of the main chain of the chemical structure:

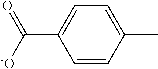

which includes the aromatic ring (benzene ring). Also, the depicted structure includes a carbon single bonded to an oxygen, double bonded to another oxygen, and single bonded to a carbon of the aromatic ring.

Thus, the ACT includes an aromatic polyester backbone. The oligomers and the ACT may be carboxylic acid-capped (capped with a carboxylic acid functional group as end group) or acetoxy-capped (capped with an acetoxy functional group as an end group). The crosslinked network of the ACT morphology may be composed of an aromatic polyester backbone interconnected via covalent single and double oxygen bonds. At least a portion of the ACT matrix is generally amorphous. The percent crystallinity may be, for example, in the range of 0% (no crystallinity) to 6%.

The downhole tools comprising a composite of a polymer matrix reinforced with degradable glass fibers are deployed or installed in a wellbore and/or a borehole at a location such that the downhole tool can perform a desired function. In embodiments, the glass fibers in the downhole tool are degraded by contacting the glass fibers with a fluid having a pH greater than 7. The fluid may include a Group I and/or a Group II hydroxide such as NaOH and/or KOH. In embodiments, a fluid having a pH greater than 7 is introduced into the wellbore and/or borehole which then contacts the downhole tool to dissolve the degradable glass fibers. In a further embodiment, the fluid having a pH greater than 7 is created at a downhole location by reacting the existing downhole fluid with a solid base precursor such as a solid Group I and/or Group II hydroxide create a fluid in-situ with a pH greater than 7. For example, solid sodium hydroxide can be dissolved to create a high pH fluid. Sodium hydroxide can dissolved in polar fluids that include water, ethanol, and methanol. The solid precursor can be anhydrous compound or a monohydrate. The solid precursor can form hydrates. The term hydrate is used to describe dissolution in any polar fluid. The solid base precursor can be encapsulated to have a delayed release, such as with a PLA plastic.

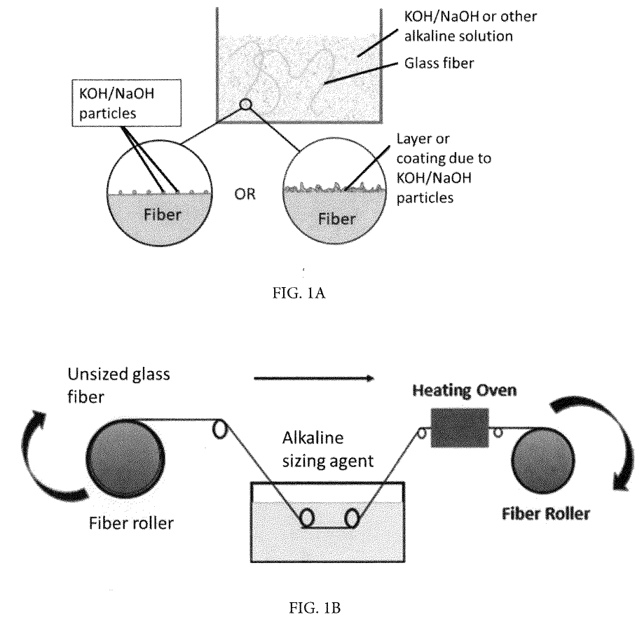

In further embodiments, the surface of the glass fibers includes a coating of a hydroxide releasing agent such as a Group I and/or a Group II hydroxide. For example, glass fibers can be treated with sodium hydroxide/potassium hydroxide at to form a coating of the hydroxide at a desired concentration. Glass fibers treated with strong bases may include quantities of Group I/II elements such as sodium on the glass fiber surface which forms when sodium hydroxide is used to treat the fibers and from the bulk of the fiber itself. Further suitable hydroxide releasing agent treatment chemicals include sodium hydroxide, potassium hydroxide, Mg(OH)₂ Ca(OH)₂, CaCO₃, MgO, CaO, ZnO, NiO, CuO, Al₂O₃, borax, sodium pentaborate, sodium tetraborate, and combinations thereof. In embodiments, the glass fibers have inclusions of solid sodium hydroxide within the glass fibers. The surface of the glass fiber may be rougher and have more irregular features characteristic of nanosheets. The formation of this layer will be largely dominated by alkali ions and not the water molecules, as the metal ions in glass fiber will be transformed to corresponding hydroxide compounds to form agglomerated platelet-like particles via a co-precipitation route under alkaline conditions. FIG. 1A illustrates a method to modify the surface of a glass fiber to include a layer of hydroxide releasing agent. In FIG. 1A glass fibers are soaked in a solution of hydroxide releasing agent (shown as KOH or NaOH solution) which then deposits the hydroxide releasing agent on the fiber. FIG. 1B illustrates an alternative method to modify the surface of a glass fiber to include a layer of hydroxide releasing agent. In FIG. 1B, the glass fiber is shown being unwound from a roller and passed into a alkaline solution containing the hydroxide releasing agent before being dried in a heating oven and re-rolled on a roller.

In embodiments where the glass fibers include a coating of a hydroxide releasing, an aqueous fluid is pumped into the wellbore or is present in the wellbore such that as water permeates through the polymer matrix to the treated glass fibers, it will create an inclusion of high pH fluid that will initiate degradation of the soluble glass fiber.

In further embodiments, a hydroxide releasing agent is included in the polymer matrix. An aqueous fluid is pumped into the wellbore or is present in the wellbore such that water permeates through the polymer matrix to the hydroxide releasing agent to create an inclusion of high pH fluid that will initiate degradation of the soluble glass fiber.

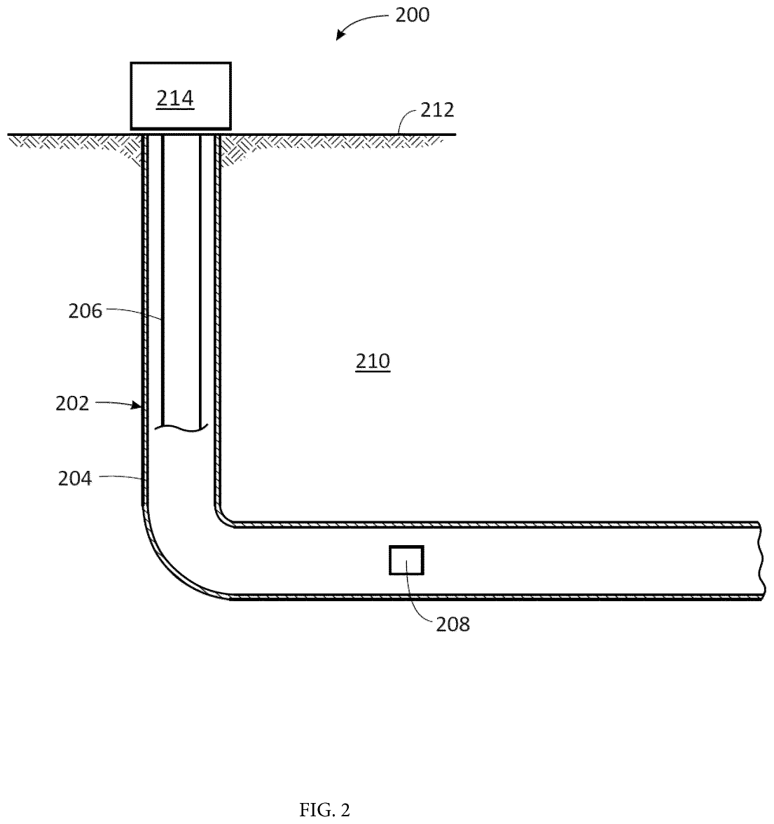

FIG. 2 illustrates a well site 200 that includes a wellbore 202 (borehole). In the illustrated implementation, wellbore 102 includes casing 104 (wellbore casing) and production tubing 206 installed in the wellbore 202. Production tubing 206 may be a tubing string utilized in the production of hydrocarbons. Wellbore 202 is formed through the Earth surface 212 into the subterranean formation 210 in the Earth crust.

Downhole tool 208 is deployed in wellbore 202. The downhole tool 208 is or includes a composite of a polymer matrix reinforced with degradable glass fibers, as discussed, and is degradable or dissolvable in the presence of an aqueous fluid having a pH greater than 7.

The downhole tool 208 is depicted as the simplified representation of a square for clarity. The downhole tool 208 may be, for example, a plug (e.g., frac plug, bridge plug, ICD plug, etc.), a packer, a gauge mandrel, a pressure housing, instrumentation (e.g., having a pressure housing), pressure barriers, frac ball, frac sleeves, perforation charge carrier, perforating guns assembly, and so on. The downhole tool 208 may include tubing, piping, a valve, etc. Some downhole tools 208 may be disposed on or near production tubing 206 in certain implementations.

For removal of the downhole tool 208 from the wellbore 202, the downhole tool 208 may be subjected to a high pH fluid, as mentioned, to dissolve the degradable glass fibers of downhole tool 208 or dissolve the polymer matrix of the downhole tool 208. The high pH dissolution fluid can include a pH greater than 7 (e.g., pH of at least 10, at least 11, at least 12, or at least 13) can be introduced into the wellbore 202 by pumping from the surface 212 or by forming the high pH dissolution fluid in the wellbore 202. The high pH dissolution fluid can be formed downhole in the wellbore 202 by reacting the existing downhole fluid with a solid precursor (e.g., solid sodium hydroxide, solid potassium hydroxide, solid calcium hydroxide, etc.) to generate a high pH fluid. For example, the solid precursor can be dissolved in the existing wellbore fluid (e.g., aqueous) to form a high pH fluid. Sodium hydroxide can dissolve in polar fluids that include water, ethanol, and methanol. The solid precursor can be anhydrous compound or a monohydrate. The solid precursor can form hydrates. The term hydrate is used to describe dissolution in any polar fluid.

In some cases, the solid precursor (e.g., solid sodium hydroxide, etc.) is compounded into the polymer matrix of the downhole tool 208. Thus, there would be inclusions of the solid precursor within the polymer matrix. The solid precursor can be coated with a barrier coating, such as PLA plastic, in order to ease incorporation of the solid precursor within the resin. As water permeates through the polymer matrix, the water reaches and hydrates the solid precursor to generate the inclusion of high pH fluid that will initiate degradation of the degradable glass fibers. In other cases, the solid precursor (e.g., solid sodium hydroxide, etc.) is placed proximate to the ACT degradable glass fibers of the downhole tool 208 and hydrates near the degradable glass fibers. The solid precursor could be part of the downhole tool 208 and be placed in the wellbore as part of the installation of the downhole tool 208. The result is a high pH fluid proximate the degradable glass fibers of the downhole tool 208 and degradation of the degradable glass fibers is initiated. Again, solid precursors to the high pH fluid include sodium hydroxide, potassium hydroxide, calcium hydroxide, and the like.

In the illustrated implementation, wellbore 202 has the casing 204 and is therefore a cased wellbore. Cement may be disposed between casing 204 and the formation 210 face. The formation 210 face can be considered a wall of wellbore 202. casing 204 may be secured within wellbore 202 by the cement. Casing 204 may be, for example, metal, plastic, composites, and the like, and may be expanded or unexpanded as part of an installation procedure.

Perforations may be formed through the casing 204 and cement for entry of fluid (e.g., hydrocarbon, water, etc.) from the subterranean formation 210 into the wellbore 202 to be produced (routed) as produced fluid through the production tubing 206 to the surface 212. A perforating gun may be sent down the wellbore 202 to blast holes (perforations) in casing 204. The surface equipment 214 may include a wellhead for receipt of the produced fluid. In other implementations, wellbore 202 can be utilized for injection of fluid from the surface 212 through the wellbore 202 and the perforations in the casing 204 (and cement) into the subterranean formation 210. The surface equipment 214 can include equipment (e.g., pumps, vessels, vehicles, etc.) for hydraulic fracturing of the subterranean formation via wellbore 202.

The surface equipment 214 can include a hoisting apparatus (e.g., for raising and lowering pipe strings) and a derrick. The surface equipment 214 and equipment deployed in wellbore 202 can include a wireline, slickline, coiled tubing, tubing string, pipe, drill pipe, drill string, and the like, that facilitates mechanical conveyance for deploying downhole tools (e.g., downhole tool 208 and other tools). The deployment of the downhole tool 208 may include lowering the downhole tool 208 into the wellbore 202 from the surface 212 and setting (e.g., via mechanical slips or other mechanisms) the downhole tool 208 in the wellbore 202. In some implementations, the equipment (e.g., wireline) may provide electrical connectivity, for example, to actuate the downhole tool 208. For example, a packer or plug may be actuated to seal off a portion of the wellbore 202. The downhole tool 208 as installed in the wellbore 202 may be permanently set, mechanically set, or hydraulically set, or any combinations thereof. The downhole tool 208 as a plug (e.g., frac plug, bridge plug, etc.) may be set to isolate a lower part of the wellbore 202.

Frac plugs are employed to isolate zones in a wellbore for hydraulic fracturing. A frac plug may play a significant role (during hydraulic fracturing) to isolate different zones of wellbore 202. Hydraulic fracturing (fracking) is a well stimulation technique which involves fracturing bedrock structures of the subterranean formation 210 by high pressure liquids to improve the production of the well having wellbore 202. The frac plug including polymer matrix reinforced with degradable glass fibers can be beneficial to speed the hydraulic fracturing operation and as an effective solution (being lightweight and dissolvable) for running in a horizontal wellbore. Considering the increasing in the length of the lateral wells, extended milling of frac plugs not dissolvable in the horizontal wellbore can be a challenge and has generally not yet been considered feasible for farthest rock bottom of wellbores.

A bridge plug may be installed to seal the wellbore 202 and/or to perform work on the wellbore 202. Bridge plugs are downhole tools that can be located in the wellbore 202 and set to isolate the lower part of the wellbore 202 (further downhole). The bridge plug is generally run in hole and set to isolate a lower zone of the wellbore 202 from an upper zone of the wellbore 202. Bridge plugs may facilitate the lower wellbore to be sealed from production or temporarily isolated from a treatment conducted on an upper zone of the wellbore 202.

A bridge plug can include slips (e.g., mechanical slips), a mandrel, and sealing element (e.g., expandable, elastomer, rubber, etc.). A bridge plug may be run (e.g., run on a wireline or pipes, and/or through a tubing string) and set (e.g., set in casing 204 or tubing 206) to isolate a lower zone of the wellbore 202 while an upper section of the wellbore 202 is tested, cemented, stimulated (e.g., hydraulically fracturing of the subterranean formation 210), produced (e.g., hydrocarbon and/or water produced from the subterranean formation 210 through the wellbore 202), or injected (injection from surface 212 through the wellbore 202 into the subterranean formation 210). The bridge plug may isolate the upper zone from the lower zone, preventing or reducing fluids of the lower zone (downhole of the plug) from reaching an upper zone (uphole of the plug) of the wellbore 202. Again, such isolation may exist while the upper zone (section) is tested, cemented, stimulated, produced, or injected either permanently or temporarily within the wellbore 202.

The downhole tool 208 as a packer may be a device that can be run into the wellbore 102 with a smaller initial outside diameter that then expands externally to seal the wellbore 202. Packers may employ flexible, elastomeric elements that expand. A packer may be a production packer, test packer, isolation packer, etc. A production packer may isolate the annulus (e.g., between the production tubing 206 and the casing wellbore 202 wall) and anchor or secure the bottom of the production tubing string. A typical packer assembly secures the packer against the casing 204 or liner wall, such as by a slip arrangement of the packer, and creates (forms) a hydraulic seal via sealing elements (e.g., an expandable elastomeric element) of the packer to isolate the annulus. The tool mandrel (and other components) of the packer (and of the frac plug, bridge plug, etc.) can be the polymer matrix reinforced with degradable glass fibers.

When set, the downhole tool 208 if a packer or plug may fluidically isolate the lower part of the wellbore 202 (downhole of the packer or plug) from an upper part of the wellbore (uphole of the packer or plug). When set, the downhole tool 208 as a packer may isolate zones of the annulus between the casing 204 and the production tubing 206 (e.g., a tubing string) by providing a seal (fluid seal) between the production tubing 206 and the casing 204. Again, in examples, a packer if the downhole tool 208 may be disposed on the production tubing 206.

It should be understood by those skilled in the art that present examples are equally well suited for use in wellbores having other directional configurations including vertical wellbore, horizontal wellbores, deviated wellbores, multilateral wells and the like. Accordingly, it should be understood by those skilled in the art that the use of directional terms such as above, below, upper, lower, upward, downward, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well. Also, even though FIG. 2 depicts an onshore operation, the present techniques are applicable for offshore operations. In addition, while FIG. 2 depicts use of the downhole tool 208 in a cased portion of wellbore 102, downhole tool 208 may also be used in uncased portions (e.g., openhole portions) of wellbore 202.

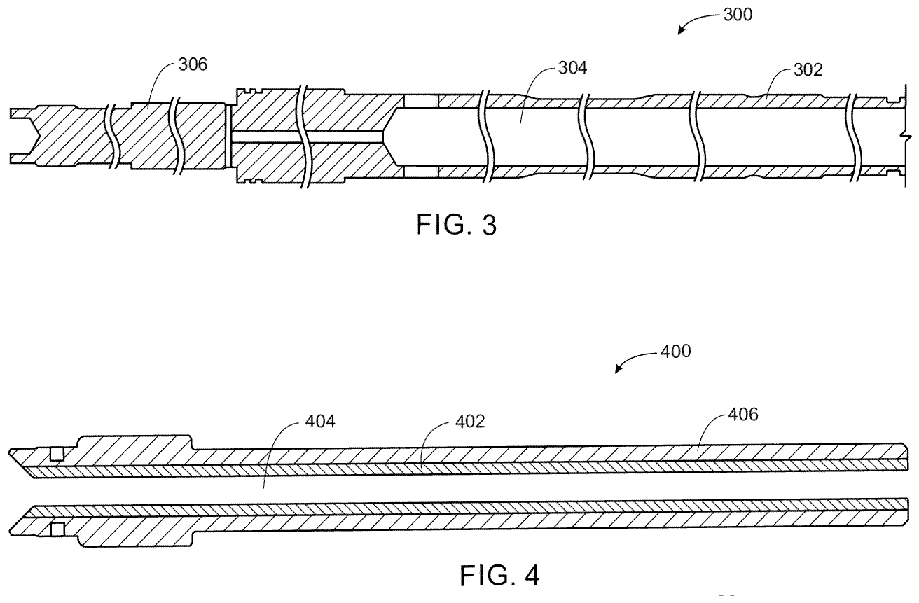

FIG. 3 is an example of a dissolvable tool mandrel 300 for a downhole tool that is an example bridge plug. The tool mandrel 300 can be a composite of polymer matrix reinforced with degradable glass fibers, and with the degradable glass fibers that is dissolved in presence of fluid having a pH greater than 7 such as of at least 11, 12, 13, or 14. The depicted tool mandrel 300 for an example bridge plug is given only as an example. A dissolvable tool mandrel that can be composite of polymer matrix reinforced with degradable glass fibers is applicable for other bridge plugs and for other downhole tools that are not a bridge plug.

In the illustrated embodiment, the tool mandrel 300 is generally cylindrical (a radial cross-section that is generally circular). The tool mandrel 300 as a dissolvable mandrel for a bridge plug is utilized in a borehole (wellbore). The depicted view is a cross section (longitudinal cross section) with the cutting plane parallel to the longitudinal axis.

The tool mandrel 300 has a wall 302 and an internal cavity 304. The wall 302 varies in wall thickness along the longitudinal length of the wall 302. In other words, the wall 302 varies in wall thickness along the longitudinal length of the tool mandrel. The tool mandrel 300 structure has a solid portion 306 with no internal cavity in a radial direction.

As for composite manufacturing techniques (systems, processes), the manufacturing technique to manufacture the downhole tools comprising a composite of a polymer matrix reinforced with degradable glass fibers may depend on the material systems discussed. The manufacturing techniques may include, for example, automated filament winding or bladder molding. Other applicable manufacturing techniques include, for instance, tape placement, autoclave molding, and so on, to manufacture the composite as the tubular mandrel profile or the tubular pressure housing profile.

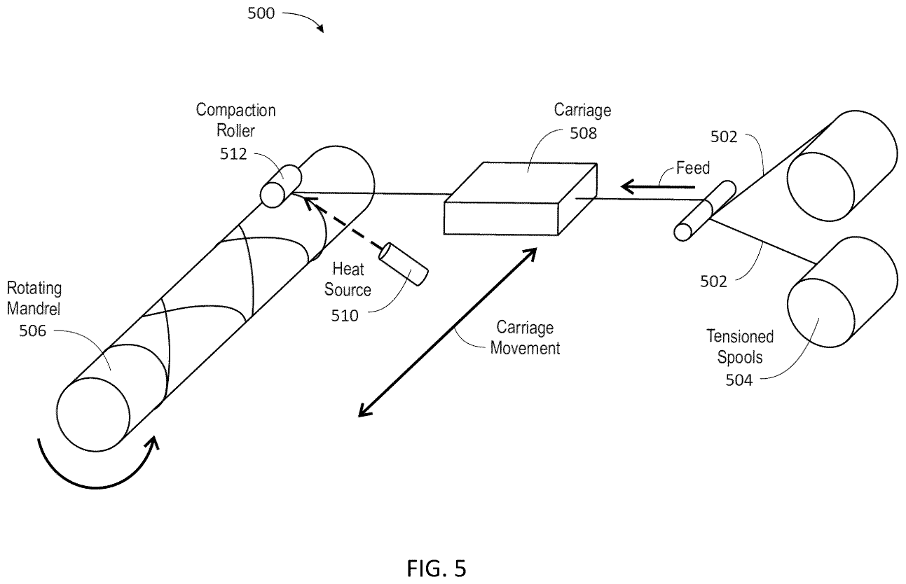

Filament winding is conventionally a manufacturing technique to produce a hollow composite where the continuous fibers are passed through separate combs into an epoxy resin bath and guided around the rotating mandrel. However, embodiments herein of the filament winding utilize a thermoplastic rather than an epoxy as the binder. Thermoplastic prepreg tapes or fiber yarns may be filament wound around a rotating mandrel guided by a carriage. A 2-axis filament winding can manufacture a constant cross-section mandrel while a mandrel with complex geometry with variable cross sections and curvatures can also be manufactured with a filament winding robot with more degree of freedoms. Filament winding is typically a continuous process, and the tapes or fiber yarns are tensioned throughout by the tensioner units. The fibers wound on the mandrel can be in-situ consolidated via a heat source and in which a compaction roller can be employed to apply pressure and provide uniform impregnation, curing, thickness and fiber volume fraction control (e.g., see FIG. 5). The heat source used for in-situ consolidation can be, for example, a conduction heater, convection heater, ultrasonic heater, infrared heater, eddy current heater, laser, and so on. The conventional consolidation routes can also be adopted if in-situ consolidation is not chosen and the part can be thermally consolidated in an oven or autoclave, or infrared, microwave radiations, and allied processes can be used to consolidate the filament wound part. The fibers can be selectively wound in particular orientations to optimize or benefit the mandrel performance under a particular loading scenario.

“Prepreg” is a common term for a reinforcing fabric which has been pre-impregnated with a polymer system. A prepreg may mean “fiber pre-impregnated with polymer.” Prepregs can be utilized to form (manufacture) composites (e.g., structural composites) including those with a fiber orientations and/or winding angles that favor hoop stress over axial stress. A prepreg is generally fiber material (e.g., woven or unidirectional fibers) impregnated with matrix material (e.g., a polymer). The prepreg is typically formed before application to manufacture a product with the prepreg. Therefore, impregnated fibers in the prepreg (e.g., formed well before application of the prepreg) may be called pre-impregnated. Thermoplastic is applicable as the resin (matrix) for the prepreg and in which the prepreg may be labeled as a thermoplastic prepreg. As discussed, prepregs have fibers (e.g., woven, non-woven, knitted, stitched, braided, wound, etc.) and can be in the form, for example, of sheets or tapes, or other forms. In implementations, the fibers may generally be continuous fibers. The prepreg (e.g., in form of sheets or tapes) may be unidirectional fibers (most or all fibers running the same direction) impregnated with a resin matrix. Filament winding may be employed to form composite structures from the prepreg.

A towpreg (also called tow prepreg) is a form of prepreg (e.g., generally having continuous fibers). Towpreg is tows of fiber pre-impregnated with resin. Towpreg is commonly utilized in filament winding applications, and can be utilized to form a composite structure that favors hoop strength over axial strength. Towpreg material can be essentially a continuous prepreg composite and can have a relatively high filament count. Towpreg winding may utilize a fiber tow that is pre-impregnated with resin (prepreg). For unidirectional tape, individual tows may aligned and then spread to form an impregnated unidirectional tape. For woven, individual tows may woven together to form a fabric before impregnation. For non-woven, tows may be arranged in a non-woven mat before impregnation.

FIG. 4 is an example mandrel configuration 400 of a downhole tool. In this implementation, the downhole tool is an example frac plug. The illustrated mandrel configuration 400 includes a dissolvable inner mandrel 402 (having an internal cavity 404) and a dissolvable inner mandrel 406. The outer mandrel profile may be formed on the inner mandrel 402. The dissolvable mandrels 402, 406 may each be constructed from a polymer matrix reinforced with degradable glass fibers, as discussed. The mandrels 402, 406 are each generally cylindrical (a radial cross-section that is generally circular). The mandrels 402, 406 as together in combination may be considered a single hollow profile having the internal cavity 404. As indicated, the example mandrel configuration 400 is for an example frac plug utilized in a borehole (wellbore). The depicted view is a longitudinal cross section.

FIG. 5 is a filament winding system 500. Filament winding can be employed to manufacture the downhole tools comprising a composite of a polymer matrix reinforced with degradable glass fibers (e.g., as a hollow profile), for example, with prepreg tapes or towpregs. The fiber angles can be varied to produce tailored laminates to meet a range of loads requirement for a particular product. In embodiments, the product of the filament winding may be a polymer matrix composite structure (e.g., the overall form of the structure as a hollow profile) for a dissolvable downhole tool.

The feed 502 can include degradable glass fibers impregnated with polymer resin, such as in the form of prepreg tapes or towpregs. As discussed, the fibers can include at least degradable glass fibers, and, in embodiments, additional fibers for example, carbon fibers, aromatic polyamide fibers (e.g., Kevlar fibers), and/or other fibers. The feed 502 (degradable glass fibers impregnated with polymer resin) can be fed, for example, from tensioned spools 504. The degradable glass fibers impregnated with polymer resin can be wound on a rotating metallic mandrel 506 to manufacture an polymer matrix reinforced with degradable glass fibers structure as or for a dissolvable downhole tool. The filament winding system 500 may include a carriage 508 that facilitates guiding the winding in the forming of the ACT composite product structure on the rotating mandrel 506. In examples, no additional pressure is typically implemented for compaction because of the tension maintained on the fibers/tapes during the filament winding. The polymer matrix composite formed as the structure on the mandrel 506 can be cured, for example, in an oven or autoclave, or similar equipment, after the winding is completed. The peak cure temperature may be, for example, in the range of 250° C. to 350° C., or in the range of 270° C. to 330° C. The cure time (e.g., the time of the polymer matrix composite in the oven or autoclave) may be, for example, in the range of 60 minutes to 240 minutes,

While conventional filament winding can be utilized, in-situ consolidation using a heat source 510 (e.g., conduction heater, convection heater, ultrasonic heater, infrared heater, eddy current heater, or laser) and a compaction roller 512 can also be relied on to apply heat and pressure, respectively. The heat source 510 may apply heat to the polymer-impregnated glass fiber being wound onto the rotating mandrel 506. The compaction roller 512 may apply pressure to the polymer-impregnated fiber being wound onto the rotating mandrel 506. In implementations, this application of heat and pressure can provide for substantially uniform impregnation and facilitate more control of the fiber volume fraction. Thus, the filament winding system 500 may include heat source 510 and the compaction roller 512 that facilitate forming of the polymer composite formed structure on the rotating mandrel 506.

A full composite cylindrical structure (no liner) can be made by demolding the composite (tube) from the metallic mandrel 506. A release agent may be applied on the metal mandrel 506 or a low friction film [e.g., polytetrafluoroethylene (PTFE)] is first wrapped on the mandrel 506, and the polymer impregnated glass fibers are wound over the release agent or low friction film on the rotating mandrel 506. This can facilitate easier demolding.

As indicated, filament winding is a composite manufacturing technique that can involve applying filament tows (e.g., glass fibers, carbon fibers, etc.) onto a mandrel. The filament layers may be cross plied to achieve the strength characteristics determined by the part designer. The applied tows can be combined with a resin matrix immediately prior to application to the mandrel (wet winding) or the tows can be a prepreg or towpreg which is the fiber/resin combination typically made well before application.

Implementations may form a composite structure (e.g., a fully composite structure) with no liner, or a hybrid composite structure (composite structure with metallic liner). The metallic liners (e.g., if employed as coupled to the composite structure) can be, for example, steel, titanium, alloys (e.g., superalloys), or other metals.

Different manufacturing techniques can be utilized to make the polymer matrix composite to give a fiber orientation or fiber winding angles that increase hoop strength while allowing for sacrifice of axial strength in implementations. The thermoplastic composite (e.g., as generally a hollow profile) can be formed, for example, by filament winding or bladder molding. The composite formed as a hollow profile can be a tubular, pressure housing, or a component (e.g., mandrel) for a downhole tool (e.g., packer), and so on. An example manufacturing technique that can be utilized to make the tubular-like profiles (e.g., pressure housing, tool mandrel, etc.) is filament winding. Other manufacturing techniques, such as tape placement or bladder molding, can also be employed to manufacture the thermoplastic composite pressure housing or the thermoplastic composite mandrel for a packer, and in which the formed structure favors hoops strength over axial strength.

For tape placement, a tape (e.g., a single tape) may passed through the feed rollers with a predefined tension and feed rate. The tape placement for composites (e.g., polymer matrix composites) may involve heating, melting, and cooling. An incoming composite tape may be bonded to a previously laid and consolidated laminate under heat and pressure locally applied to the interface. By laying additional layers in different directions, a part with desired thickness and properties can be fabricated. An example of tape placement is automated tape placement (ATP) composite manufacturing. In examples, the fiber placement process automatically places multiple individual pre-impregnated tows onto a mandrel at relatively high speed, employing a numerically controlled placement head to dispense, clamp, cut and restart each tow during placement. Tape laying is with prepregged tape, rather than single tows, laid down (e.g., continuously) to form parts.

Bladder molding is a manufacturing technique for composite parts (e.g., hollow composite parts). In bladder molding, a composite material may be applied to a bladder and the part inserted into a female cavity mold. A press may clamp the mold shut and heat applied to cure the part. Applied air pressure can force the laminate outward in the cavity, consolidating the material in the closed mold. The bladder may be removed after cure and the remaining end product is a hollow structure. The bladder molding may begin with fibers (e.g., sheets of fibers) impregnated with thermoplastic and that can be a prepreg. The prepreg sheets may be wrapped around an inflatable bladder, and then placed inside the mold cavity and the mold closed. Once the mold is closed, the mold may apply pressure to the inside of the bladder. Pressure may cause the bladder to expand and push on the resin-filled fibers. The pressure pushes outward against the inside of the mold cavity. Then, heat may be applied to the mold to solidify the part, or also known as curing. The component fibers form in the shape of the inside the mold cavity. Once cured, the mold may be opened, revealing the hardened hollow part, and the bladder may be removed from the inside.

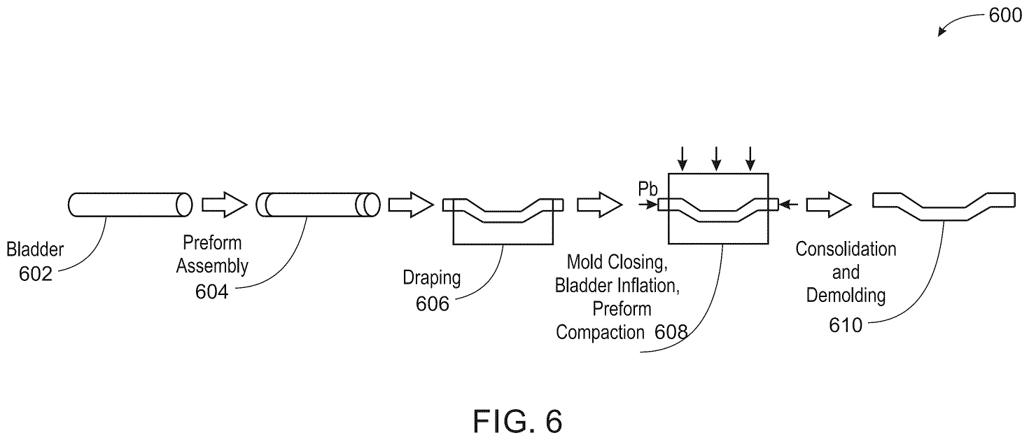

FIG. 6 is a bladder molding technique 600 depicting a bladder 602, a preform assembly 704, draping 706, the actions 708 of mold closing, bladder inflation, and preform compaction, and the actions 710 of consolidation and demolding. As mentioned, a technique to manufacture the composite mandrel or composite pressure housing can be bladder molding. In bladder molding, the tubular-like preform can be made by wrapping a thermoplastic prepreg around the mandrel to achieve a desired layup of the fibers that gives, for example, increased hoop strength including with the option of sacrificing (decreasing) axial strength as desired to increase hoop strength as configured. This can be done by individually laying a fiber as specified orientation or winding angle around the mandrel or by making a preform of layers by placing the layers on top of each other and then wounding the entire preform around the mandrel to give the specified fiber orientation. This can be done manually or using an automated preforming device to achieve compaction. The preform can be removed from the mandrel and placed inside the mold cavity, and the inflatable bladder utilized to pressurize the preform (e.g., in the range of 6 bars absolute to 20 bars absolute) to drape the preform across the wall of the cavity and produce a hollow composite structure by heating the mold at the desired temperature based on the selection of the matrix material. This process can be adopted for complex tubular profiles. For a composite with a metallic or thermoplastic base/liner, the preform can be wound around the base/liner and the hybrid tubular can be placed in an autoclave or oven for consolidation.

In view of the foregoing, the present disclosure may downhole equipment (e.g., downhole tool mandrels, downhole pressure housings, etc.) that are a composite of thermoplastic reinforced with fibers in which the fiber placement (orientation, winding angles) favors hoop strength over axial strength. The methods, systems, and tools may include any of the various features disclosed herein, including one or more of the following statements.

Statement 1. A method for removing a downhole tool comprising: contacting a downhole tool with a fluid having a pH of greater than 7, wherein the downhole tool comprises a composite of a polymer matrix reinforced with degradable glass fibers; and degrading the degradable glass fibers using the fluid having a pH of greater than 7.

Statement 2. The method of statement 1 wherein the fluid having a pH of greater than 7 is pumped through a wellhead and contacts the downhole tool.

Statement 3. The method of any of statements 1-2 wherein the downhole tool is disposed in a wellbore and/or a borehole and the fluid having a pH of greater than 7 is generated within the wellbore and/or the borehole and contacts the downhole tool.

Statement 4. The method of any of statements 1-3 wherein the fluid comprises a Group I and/or a Group II hydroxide.

Statement 5. The method of any of statements 1-4 wherein the polymer matrix comprises at least one polymer selected from the group consisting of a thermoset polymer, a thermoplastic polymer, aromatic copolyester thermoset, an aliphatic polyester, and combinations thereof.

Statement 6. The method of any of statements 1-5 wherein the polymer matrix comprises at least thermoplastic polymer selected from the group consisting of acrylonitrile butadiene styrene (ABS), nylon, acrylic, polyetherimide (PEI), polyether ether ketone (PEEK), polyetherketoneketone (PEKK), and combinations thereof.

Statement 7. The method of any of statements 1-6 wherein the polymer matrix comprises at least one aliphatic polyester selected from the group consisting of poly(lactic acid) (PLA), poly(ε-caprolactone), poly(glycolic acid) (PGA), poly(lactic-co-glycolic acid), poly(hydroxyl ester ether), poly(hydroxybutyrate), poly(anhydride), polycarbonate, poly(amino acid), poly(ethylene oxide), poly(phosphazene), polyether ester, polyester amide, polyamides, sulfonated polyesters, poly(ethylene adipate), polyhydroxyalkanoate, poly(ethylene terephtalate), poly(butylene terephthalate), poly(trimethylene terephthalate), poly(ethylene naphthalate), and combinations thereof.

Statement 8. The method of any of statements 1-7 wherein the downhole tool comprises at least one tool selected from the group consisting of a frac plug, a frac sleeve, a frac ball, a ball seat, a bridge plug, an inflow control device (ICD) plug, a wiper plug, a packer, a mandrel, a gauge mandrel, a pressure housing, a tubing, a piping, a valve, a perforating gun assembly, a perforation charge carrier, and combinations thereof.

Statement 9. The method of any of statements 1-8 wherein the degradable glass fibers comprise at least one glass selected from the group consisting of C glass, D glass, E glass, E glass with boron, E glass without boron, ECR glass, R glass, S2 glass, and combinations thereof.

Statement 10. The method of any of statements 1-9 wherein the tool further comprises an additional fiber selected from the group consisting of carbon fiber, aramid fiber, boron based fibers, basalt fibers, metal fibers, polyethylene fibers, polypropylene fibers, poly(p-phenylene-2,6-benzobisoxazole) fibers, and combinations thereof.

Statement 11. A method for removing a downhole tool comprising: contacting a downhole tool with an aqueous fluid, wherein the downhole tool comprises a composite of a polymer matrix reinforced with degradable glass fibers; generating a fluid having a pH of greater than 7 within the downhole tool; and degrading the degradable glass fibers using the fluid having a pH of greater than 7.

Statement 12. The method of statement 11 wherein generating the fluid having a pH of greater than 7 comprises contacting the aqueous fluid with a hydroxide releasing agent selected form the group consisting of a Group I and/or a Group II hydroxide, CaCO₃, MgO, CaO, ZnO, NiO, CuO, Al₂O₃, borax, sodium pentaborate, sodium tetraborate, and combinations thereof.

Statement 13. The method of any of claims 11-12 wherein the polymer matrix comprises hydroxide releasing agent and wherein the fluid having a pH of greater than 7 is generated within the polymer matrix.

Statement 14. The method of any of statements 11-13 wherein the degradable glass fibers comprise a hydroxide releasing agent disposed on a surface of the degradable glass fibers and wherein the fluid having a pH of greater than 7 is generated proximate to the surface of the degradable glass fibers.

Statement 15. The method of any of statements 11-14 wherein the polymer matrix comprises at least one polymer selected from the group consisting of a thermoset polymer, a thermoplastic polymer, aromatic copolyester thermoset, an aliphatic polyester, and combinations thereof.

Statement 16. The method of any of statements 11-15 wherein the polymer matrix comprises at least thermoplastic polymer selected from the group consisting of acrylonitrile butadiene styrene (ABS), nylon, acrylic, polyetherimide (PEI), polyether ether ketone (PEEK), polyetherketoneketone (PEKK), and combinations thereof.

Statement 17. The method of any of statements 11-16 wherein the polymer matrix comprises at least one aliphatic polyester selected from the group consisting of poly(lactic acid) (PLA), poly(ε-caprolactone), poly(glycolic acid) (PGA), poly(lactic-co-glycolic acid), poly(hydroxyl ester ether), poly(hydroxybutyrate), poly(anhydride), polycarbonate, poly(amino acid), poly(ethylene oxide), poly(phosphazene), polyether ester, polyester amide, polyamides, sulfonated polyesters, poly(ethylene adipate), polyhydroxyalkanoate, poly(ethylene terephtalate), poly(butylene terephthalate), poly(trimethylene terephthalate), poly(ethylene naphthalate), and combinations thereof.

Statement 18. The method of any of statements 11-17 wherein the downhole tool comprises at least one tool selected from the group consisting of a frac plug, a frac sleeve, a frac ball, a ball seat, a bridge plug, an inflow control device (ICD) plug, a wiper plug, a packer, a mandrel, a gauge mandrel, a pressure housing, a tubing, a piping, a valve, a perforating gun assembly, a perforation charge carrier, and combinations thereof.

Statement 19. The method of any of statements 11-18 wherein the degradable glass fibers comprise at least one glass selected from the group consisting of C glass, D glass, E glass, E glass with boron, E glass without boron, ECR glass, R glass, S2 glass, and combinations thereof.

Statement 20. The method of any of statements 11-19 wherein the tool further comprises an additional fiber selected from the group consisting of carbon fiber, aramid fiber, boron based fibers, basalt fibers, metal fibers, polyethylene fibers, polypropylene fibers, poly(p-phenylene-2,6-benzobisoxazole) fibers, and combinations thereof.

To facilitate a better understanding of the present invention, the following examples of certain aspects of some embodiments are given. In no way should the following examples be read to limit, or define, the entire scope of the disclosure.

### Example

In this example, glass fibers were tested for dissolution in sodium hydroxide solution. Woven plain weave E-glass fibers were added to a pH 14.3 sodium hydroxide solution at 93° C. After 18 hours, the woven glass fibers were removed from the solution and assess for change in texture and appearance. Prior to treatment, the glass fibers were observed to be ductile. After treatment, the glass fibers were significantly embrittled and break easily on application of light manual pressure. The treated glass fibers were observed to disintegrate into flakes under light manual pressure.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

The present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method for removing a downhole tool comprising:
contacting a downhole tool with a fluid having a pH of greater than 7, wherein the downhole tool comprises a composite of a polymer matrix reinforced with degradable glass fibers; and
degrading the degradable glass fibers using the fluid having a pH of greater than 7.

2. The method of claim 1 wherein the fluid having a pH of greater than 7 is pumped through a wellhead and contacts the downhole tool.

3. The method of claim 1 wherein the downhole tool is disposed in a wellbore and/or a borehole and the fluid having a pH of greater than 7 is generated within the wellbore and/or the borehole and contacts the downhole tool.

4. The method of claim 1 wherein the fluid comprises a Group I and/or a Group II hydroxide.

5. The method of claim 1 wherein the polymer matrix comprises at least one polymer selected from the group consisting of a thermoset polymer, a thermoplastic polymer, aromatic copolyester thermoset, an aliphatic polyester, and combinations thereof.

6. The method of claim 1 wherein the polymer matrix comprises at least thermoplastic polymer selected from the group consisting of acrylonitrile butadiene styrene (ABS), nylon, acrylic, polyetherimide (PEI), polyether ether ketone (PEEK), polyetherketoneketone (PEKK), and combinations thereof.

7. The method of claim 1 wherein the polymer matrix comprises at least one aliphatic polyester selected from the group consisting of poly(lactic acid) (PLA), poly(ε-caprolactone), poly(glycolic acid) (PGA), poly(lactic-co-glycolic acid), poly(hydroxyl ester ether), poly(hydroxybutyrate), poly(anhydride), polycarbonate, poly(amino acid), poly(ethylene oxide), poly(phosphazene), polyether ester, polyester amide, polyamides, sulfonated polyesters, poly(ethylene adipate), polyhydroxyalkanoate, poly(ethylene terephtalate), poly(butylene terephthalate), poly(trimethylene terephthalate), poly(ethylene naphthalate), and combinations thereof.

8. The method of claim 1 wherein the downhole tool comprises at least one tool selected from the group consisting of a frac plug, a frac sleeve, a frac ball, a ball seat, a bridge plug, an inflow control device (ICD) plug, a wiper plug, a packer, a mandrel, a gauge mandrel, a pressure housing, a tubing, a piping, a valve, a perforating gun assembly, a perforation charge carrier, and combinations thereof.

9. The method of claim 1 wherein the degradable glass fibers comprise at least one glass selected from the group consisting of C glass, D glass, E glass, E glass with boron, E glass without boron, ECR glass, R glass, S2 glass, and combinations thereof.

10. The method of claim 1 wherein the tool further comprises an additional fiber selected from the group consisting of carbon fiber, aramid fiber, boron based fibers, basalt fibers, metal fibers, polyethylene fibers, polypropylene fibers, poly(p-phenylene-2,6-benzobisoxazole) fibers, and combinations thereof.

11. A method for removing a downhole tool comprising:
contacting a downhole tool with an aqueous fluid, wherein the downhole tool comprises a composite of a polymer matrix reinforced with degradable glass fibers;
generating a fluid having a pH of greater than 7 within the downhole tool; and
degrading the degradable glass fibers using the fluid having a pH of greater than 7.

12. The method of claim 11 wherein generating the fluid having a pH of greater than 7 comprises contacting the aqueous fluid with a hydroxide releasing agent selected form the group consisting of a Group I and/or a Group II hydroxide, CaCO₃, MgO, CaO, ZnO, NiO, CuO, Al₂O₃, borax, sodium pentaborate, sodium tetraborate, and combinations thereof.

13. The method of claim 11 wherein the polymer matrix comprises hydroxide releasing agent and wherein the fluid having a pH of greater than 7 is generated within the polymer matrix.

14. The method of claim 11 wherein the degradable glass fibers comprise a hydroxide releasing agent disposed on a surface of the degradable glass fibers and wherein the fluid having a pH of greater than 7 is generated proximate to the surface of the degradable glass fibers.

15. The method of claim 11 wherein the polymer matrix comprises at least one polymer selected from the group consisting of a thermoset polymer, a thermoplastic polymer, aromatic copolyester thermoset, an aliphatic polyester, and combinations thereof.

16. The method of claim 11 wherein the polymer matrix comprises at least thermoplastic polymer selected from the group consisting of acrylonitrile butadiene styrene (ABS), nylon, acrylic, polyetherimide (PEI), polyether ether ketone (PEEK), polyetherketoneketone (PEKK), and combinations thereof.

17. The method of claim 11 wherein the polymer matrix comprises at least one aliphatic polyester selected from the group consisting of poly(lactic acid) (PLA), poly(ε-caprolactone), poly(glycolic acid) (PGA), poly(lactic-co-glycolic acid), poly(hydroxyl ester ether), poly(hydroxybutyrate), poly(anhydride), polycarbonate, poly(amino acid), poly(ethylene oxide), poly(phosphazene), polyether ester, polyester amide, polyamides, sulfonated polyesters, poly(ethylene adipate), polyhydroxyalkanoate, poly(ethylene terephtalate), poly(butylene terephthalate), poly(trimethylene terephthalate), poly(ethylene naphthalate), and combinations thereof.

18. The method of claim 11 wherein the downhole tool comprises at least one tool selected from the group consisting of a frac plug, a frac sleeve, a frac ball, a ball seat, a bridge plug, an inflow control device (ICD) plug, a wiper plug, a packer, a mandrel, a gauge mandrel, a pressure housing, a tubing, a piping, a valve, a perforating gun assembly, a perforation charge carrier, and combinations thereof.

19. The method of claim 11 wherein the degradable glass fibers comprise at least one glass selected from the group consisting of C glass, D glass, E glass, E glass with boron, E glass without boron, ECR glass, R glass, S2 glass, and combinations thereof.

20. The method of claim 11 wherein the tool further comprises an additional fiber selected from the group consisting of carbon fiber, aramid fiber, boron based fibers, basalt fibers, metal fibers, polyethylene fibers, polypropylene fibers, poly(p-phenylene-2,6-benzobisoxazole) fibers, and combinations thereof.
